(19) United States
(12) Patent Application Publication
(10) Pub. No.: US 2025/0375738 A1
(43) Pub. Date: Dec. 11, 2025

(54) REVERSE OSMOSIS BRINE AS INJECTION WATER FOR RESERVOIR

(71) Applicant: Saudi Arabian Oil Company, Dhahran (SA)

(72) Inventors: Seung-Hak Choi, Incheon (KR); Abdulaziz Y. Ammar, Dammam (SA); Yohannes Hilawe, Ras Tanura (SA); Abdullah Khalid Alamoudi, Dammam (SA); Nuha A. Alnahwi, Dhahran (SA)

(21) Appl. No.: 18/738,342

(22) Filed: Jun. 10, 2024

(51) Int. Cl. B01D 61/58; B01D 61/00; B01D 61/02; B01D 61/06; B01D 61/36; C01F 5/14; C02F 1/44; C02F 9/00; C09K 8/58

(52) U.S. Cl. CPC B01D 61/58; B01D 61/029; B01D 61/06; C01F 5/14; C02F 9/00; C09K 8/58; B01D 61/002; B01D 61/025; B01D 61/0271; B01D 61/364; B01D 2317/022; B01D 2317/025; B01D 2317/08; C02F 1/441; C02F 1/442; C02F 1/445; C02F 1/447; C02F 2301/08; C02F 2303/10

(57) ABSTRACT

A method for producing an injection water for a reservoir includes receiving a brine that is produced based on a reverse osmosis of water, performing a separation of the brine, producing a concentrated brine based on the separation of the brine, and producing, based on the concentrated brine, the injection water suitable for use in maintaining a reservoir pressure. Performing the separation of the brine includes performing at least one of a filtration, a membrane distillation, or a forward osmosis. The concentrated brine has a lower sulfate level and NaCl level and a higher total dissolved solids (TDS) level than the brine.

### TECHNICAL FIELD

The present disclosure is directed to the reuse of seawater. Specifically, brine formed from the seawater is used to form injection water for reservoir.

### BACKGROUND

Injection water is used in oil and gas production to help extract more oil from the earth. When oil and gas are pumped out, the pressure in the underground reservoir decreases, making it harder to extract the remaining oil or gas. To counter this, water (e.g., injection water) is injected back into the reservoir. This process helps to maintain or increase the pressure in the reservoir, which in turn pushes the oil towards the production wells, making it easier to extract.

The injection water needs to be treated to remove impurities, because untreated injection water can damage the underground reservoir or block the flow of oil. Further, the amount of water injected can be controlled as to enhance its effectiveness and efficiency in maintaining the appropriate pressure.

### SUMMARY

A method for producing an injection water for a reservoir is disclosed. The method includes receiving a brine that is produced based on a reverse osmosis of water, performing a separation of the brine, producing a concentrated brine based on the separation of the brine, and producing, based on the concentrated brine, the injection water suitable for use in maintaining a reservoir pressure. Performing the separation of the brine includes performing at least one of a filtration, a membrane distillation, or a forward osmosis. The concentrated brine has a lower sulfate level and NaCl level and a higher total dissolved solids (TDS) level than the brine.

A system for producing an injection water for a reservoir is disclosed. The system includes a nanofiltration unit and a membrane distillation unit. The nanofiltration unit is configured to receive a brine that is produced based on a reverse osmosis of water, perform a rejection of NaCl and sulfate of the brine, and generate a permeate and a retentate based on the brine. The membrane distillation unit is configured to receive the permeate from the nanofiltration unit and generate, based on the permeate, a concentrated brine for use in producing injection water for a reservoir. The concentrated brine has a lower sulfate level and NaCl level and a higher total dissolved solids (TDS) level than the brine.

### BRIEF DESCRIPTION OF DRAWINGS

FIG. 1 is a schematic diagram of an example of production of injection water based on seawater reverse osmosis brine.

FIG. 2 is a schematic diagram of an example of nanofiltration unit.

FIGS. 3A-3D are schematic diagrams of examples of a direct contact membrane distillation unit, an air gap membrane distillation unit, a vacuum membrane distillation unit, or a sweep gas membrane distillation unit that can be used for brine concentration process.

FIG. 4 is a schematic diagram of an example of a forward osmosis unit.

FIGS. 5A-5D are schematic diagrams of examples of a direct contact membrane distillation unit, an air gap membrane distillation unit, a vacuum membrane distillation unit, or a sweep gas membrane distillation unit that can be used for brine mining process.

FIG. 6 is a schematic diagram of an example of brine mining process to produce magnesium, barium, or calcium based on nanofiltration retentate.

FIG. 7 is a block diagram of an example of production of injection water based on seawater reverse osmosis brine.

FIG. 8 is a graph depicting rejection rates of NaCl and sulfate of an example of a commercial nanofiltration membrane based on various operating conditions.

### DETAILED DESCRIPTION

Seawater Reverse Osmosis (SWRO) is a technology used to convert seawater into fresh water (e.g., fresh desalinated water, purified water). During the SWRO process, the fresh water and brine are produced. Throughout this disclosure, brine produced by the SWRO will be referred to as SWRO brine. The SWRO brine typically contains high levels of salt and other minerals, making it unsuitable for human consumption. For example, the SWRO brine includes high sulfate concentration relative to original seawater, treated water, or the fresh water. The disposal of the SWRO brine is an ongoing environment concern and proper brine disposal is essential to minimize its environmental impact and ensure that the marine ecosystem is not harmed.

In the meantime, maintaining optimal reservoir pressure is a paramount objective for the sustainable and efficient production of oil and gas. As reservoirs mature and natural pressure declines, injection of water into the reservoir (commonly known as “injection water” or “waterflooding”) is required.

Currently, nonrenewable groundwater has been used as injection water. The use of SWRO brine can significantly reduce groundwater consumption and resolve the challenges for SWRO brine disposal at the same time. However, due to compatibility issues, the SWRO brine has to be first treated before use as the injection water. For instance, the presence of high levels of total dissolved solids (TDS), sulfate, total suspended solids (TSS), particle size, pH, dissolved O2 and gases contents, oil and biocide and iron contents may cause fouling or other damage to a reservoir.

Implementations described in this disclosure provides a method for producing the injection water using the SWRO brine. In some implementations, different combinations of membrane-based technologies are used to meet the requirements in terms of the sulfate concentration level and the TDS level. For example, first, nanofiltration (NF) membrane operation is performed on the SWRO brine to reduce the sulfate concentration level or satisfy desired sulfate concentration level. In such NF membrane operation, one or more NF units are utilized to reduce the sulfate concentration level or satisfy desired sulfate concentration level without additional compression of SWRO brine to operate NF process. For example, by the one or more NF units utilizing or incorporating a pressure letdown system that is configured to control the feed pressure in a range of 50-600 psi, additional pump is not needed to generate hydraulic pressure for NF operation.

Thereafter, a membrane distillation (MD) or a forward osmosis (FO) is performed to increase the TDS level of the SWRO brine and form the concentrated SWRO brine. Such concentrated SWRO brine is used as, or further processed to produce, the injection water. Performing the NF membrane operation before any other process (e.g., MD, FO) to remove sulfate or multivalent ions would lead to the production of relatively lower TDS than feed (SWRO brine) prior to the subsequent process (e.g., MD, FO), which in turn, would enhance the efficiency of the MD or the FO process and lead to relatively easier selection of material and configuration of the process. For example, pre-treatment with NF unit allows for a broader range of materials to be considered for the FO and MD membrane selection, since the NF unit can remove substances that may be aggressive towards certain membrane materials (e.g. dissolved organics). The chemical composition and structure of the membrane affect its selectivity, flux, and resistance to fouling. The membrane configurations such as Spiral-wound, hollow-fiber, and flat-sheet are common configurations, each with advantages in specific applications based on flow dynamics and case of cleaning. Further, by removing larger particles and a significant fraction of dissolved substances, the NF unit can prevent or reduce fouling and scaling on FO and MD membranes. This leads to longer membrane life, less frequent cleaning, and potentially lower operating pressures. The reduced load on the FO and MD units allows for a more flexible configuration. Thus, it may be possible to use fewer FO and/or MD stages or operate at lower pressures, which can influence the design and operational costs positively.

Accordingly, based on implementations of combined membrane-based processes, the SWRO brine is fully utilized as injection water. In addition to producing injection water, other minerals and purified water are produced as by-products, which can be utilized for human consumption (e.g., regarding purified water) or for other purposes.

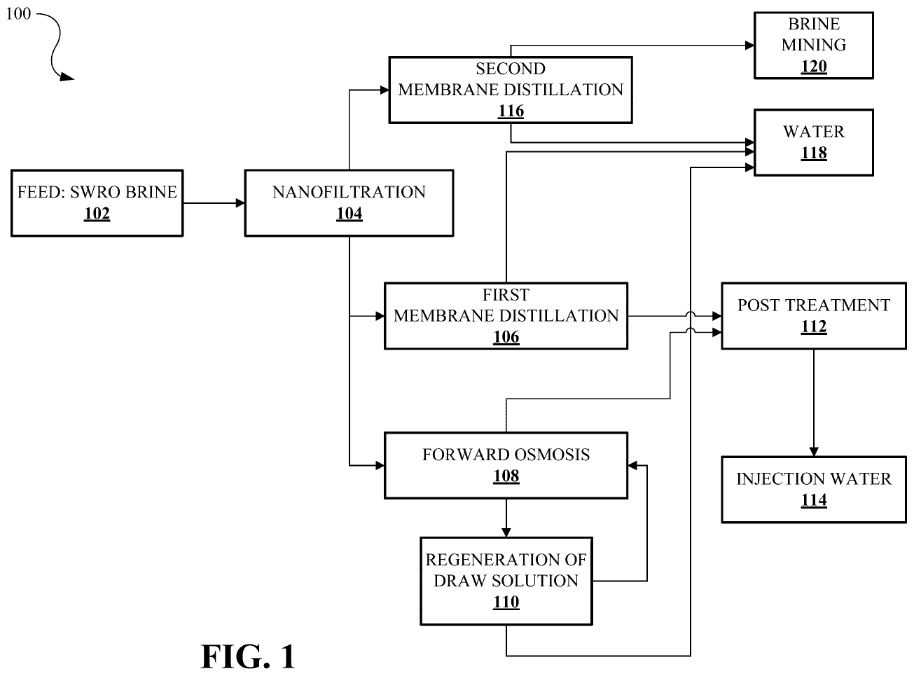

FIG. 1 is a schematic diagram 100 of an example of production of injection water based on seawater reverse osmosis (SWRO) brine. For example, the schematic diagram 100 includes a system for producing the injection water based on the SWRO brine. The system includes a nanofiltration unit 104, a first membrane distillation unit 106, a forward osmosis unit 108, and a second membrane distillation unit 116.

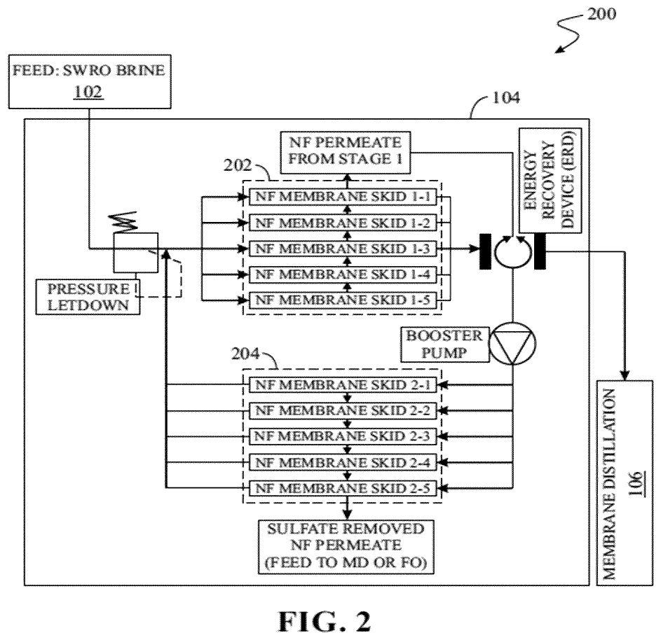

The nanofiltration (NF) unit 104 is a nanofiltration system or an equipment that uses a membrane to separate particles or dissolved substances from a fluid. For example, the NF unit 104 can receive the SWRO brine 102 feed and reduce the sulfate concentration level of the SWRO brine 102 or NaCl concentration level of the SWRO brine 102. For example, the NF unit 104 can include a pressure letdown system (as shown in FIG. 2) configured to control the feed pressure in a range of 50-600 psi. By utilizing or incorporating the pressure letdown system that can reduce the feed pressure to the NF unit 104, the NF unit 104 does not require additional pump to generate the hydraulic pressure for NF operation. Depending on the characteristics of the NF membrane used, some dissolved solids (NaCl) and water can penetrate while others (multivalent ions such as calcium (Ca), magnesium (Mg), sulfate and a portion of NaCl) can be rejected by the membrane. Moreover, the rejection rate of each of the components can vary depending on the membrane used in the process and operating conditions such as recovery rate of water, feed pressure and flow rate or membrane area. For example, the NF unit 104 can utilize different NF membranes to reduce the sulfate concentration level or the NaCl concentration level to approximately satisfy certain desired level of the sulfate concentration or the NaCl concentration.

The NF unit 104 can utilize commercial NF membranes that are capable of filtering or separating certain targeted particles. For example, the NF unit 104 can utilize a CSM NE8040-40 from Toray Membrane, an XN45 from TriSep Corporation, an NFW and an NFX from Synder Filtration and an SWSR from General Electric. For example, the nanofiltration unit 104 can utilize NF membranes that can perform a rejection of NaCl and sulfates at certain rejection rates. For example, NaCl and sulfate rejection rates are the key factors in choosing the membranes and the NF membranes with low NaCl rejection (e.g., less than 60%) and high sulfate (e.g., MgSO₄) rejection rates (e.g., over 90%) are preferred. For example, the membranes with NaCl rejection rate less than 60%, and sulfate rejection rate that is greater higher than 90% are preferred. For example, the membranes with NaCl rejection rate less than 50%, and the sulfate rejection rate that is greater higher than 90% are preferred.

In some implementations, the NF unit 104 corresponds to or includes a plurality of nanofiltration units (e.g., multi-NF unit) or a nanofiltration unit that includes a plurality of nanofiltration membranes. FIG. 2 shows a schematic diagram 200 of an operation of an example of the NF unit 104. For example, to meet the specific requirements of the injection water, the sulfate concentration can be closely monitored, and if necessary, the permeate stream can be fed to another NF unit. For example, in such cases (e.g., permeate stream being fed to another NF unit), the permeate can pass through an energy recovery device (as shown in FIG. 2) to recover energy and pressurize the permeate stream from a first NF unit 202, which then passes through a booster pump before being fed to a second NF unit 204.

In some implementations, when the plurality of NF units or the multi-NF unit is used, the multi-NF unit lowers the sulfate concentration to less than or equal to 500 ppm. For example, a first NF unit is performed to generate a first permeate stream, and when the first permeate stream is higher than the threshold value of sulfate concentration (e.g., 500 ppm), a second NF unit on the first permeate stream is performed to generate a second permeate stream. As such, multistage nanofiltration can be performed until the sulfate concentration in the permeate stream is reduced to less than or equal to the threshold value (e.g., 500 ppm) of sulfate concentration. For example, the sulfate concentration can be reduced to 100˜500 ppm. As shown in FIG. 2, when designing the multi-NF unit, an energy recovery device (ERD) can be used to recover retentate stream pressure and pre-compress the feed stream. Accordingly, the NF unit 104 can receive the SWRO Brine 102 and filter sulfate at certain respective rejection rate.

The NF unit 104 directs (i) the permeate stream to the first membrane distillation unit 106 or the forward osmosis unit 108 and (ii) the retentate stream (e.g., stream that includes rejected particles or substances) to the second membrane distillation unit 116.

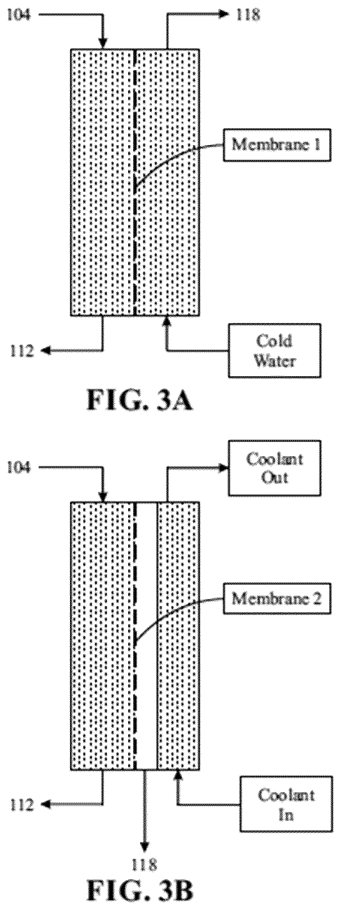

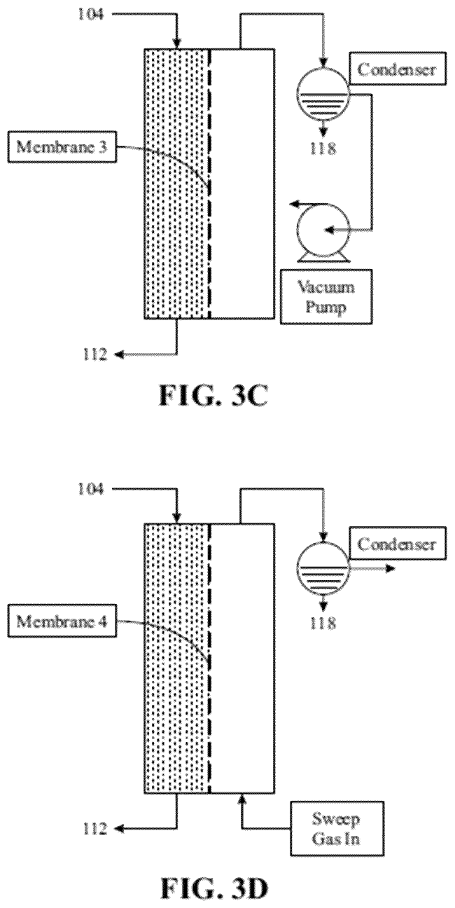

The first membrane distillation (MD) unit 106 is used to concentrate the sulfate concentration-controlled SWRO brine from the permeate stream of the NF unit 104 (e.g., NF permeate). For example, as shown in FIGS. 3A-3D, the first membrane distillation unit 106 can include or correspond to at least one of a direct contact membrane distillation (DCMD) unit depicted in FIG. 3A, an air gap membrane distillation (AGMD) unit depicted in FIG. 3B, a vacuum membrane distillation (VMD) unit depicted in, FIG. 3C, or a sweep gas membrane distillation (SGMD) unit depicted in FIG. 3D.

Regarding the DCMD unit of FIG. 3A, the AGMD unit of FIG. 3B, the VMD unit of FIG. 3C, and the SGMD unit of FIG. 3D, each of these four units can receive the NF permeate from the NF unit 104, concentrate the SWRO brine from the NF permeate, and output the concentrated SWRO brine to post treatment process 112. Moreover, purified water can be produced as by-product (e.g., portion of water 118).

For example, regarding the DCMD unit of FIG. 3A, an aqueous solution colder than the feed solution can be maintained in direct contact with the permeate side of a membrane (e.g., membrane 1). In this configuration, the transmembrane temperature difference can induce a (water) vapor pressure difference. Consequently, volatile molecules can evaporate at the hot liquid/vapor interface, cross the membrane pores in vapor phase, and condense in the cold liquid/vapor interface inside the membrane module.

For example, regarding the AGMD unit of FIG. 3B, a stagnant air gap can be interposed between a membrane (e.g., membrane 2) and a condensation surface. In this case, the evaporated volatile molecules can cross both the membrane pores and the air gap to finally condense over a cold surface inside the membrane module.

For example, regarding the VMD unit of FIG. 3C, a vacuum can be applied in the permeate side of a membrane (e.g., membrane 3) by means of a vacuum pump. The applied vacuum pressure can be lower than the saturation pressure of volatile molecules (e.g., water) to be separated from the feed solution. In this configuration, condensation takes place outside of the membrane.

For example, regarding the SGMD unit of FIG. 3D, a cold inert gas can sweep the permeate side of a membrane (e.g., membrane 4) carrying the vapor molecules and condensation can take place outside the membrane module. In this configuration, due to the heat transferred from the feed side through the membrane, the sweeping gas temperature in the permeate side can increase considerably along the membrane module length.

Consequently, the first membrane distillation unit 106 is used to concentrate the SWRO brine of the permeate stream from the NF unit 104 (e.g., NF permeate). For example, the first membrane distillation unit 106 can increase the TDS level of the SWRO brine of the NF permeate (that includes reduced sulfate and NaCl) to satisfy a certain TDS level for being injected (e.g., as injection water 114) into the reservoir for pressure maintenance.

The concentrated SWRO brine (of the permeate stream of the first MD unit 106) is directed to the post-treatment process 112 before being injected into the reservoir.

Moreover, produced purified water (e.g., portion of water 118) from the first MD unit 106 can be used within a plant for various applications or stored in a storage.

In addition to, or independently from, the first MD unit 106, the forward osmosis (FO) unit 108 is used to concentrate the SWRO brine that is fed from the permeate stream of the NF unit 104 (e.g., NF permeate). For example, the NF permeate (e.g., including reduced sulfate and NaCl) is introduced to or received by the FO unit 108 and the FO unit 108 further increases the TDS level of received NF permeate to satisfy a certain TDS level to be injected (e.g., as injection water 114) into the reservoir for pressure maintenance.

In general, the FO unit 108 conducts a forward osmosis (FO) operation (e.g., process). Regarding the FO unit 108, a draw solution that has higher osmotic pressure than the NF permeate is used to extract water from the NF permeate through a semi-permeable membrane. During the FO operation, the draw solution may be diluted and may need to be regenerated.

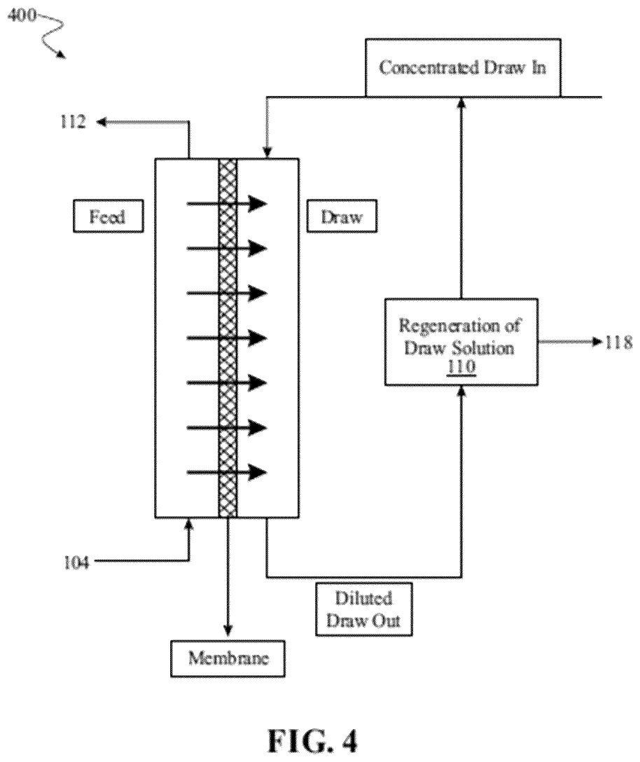

For example, FIG. 4 is a schematic diagram 400 of an example of the FO unit 108. The FO unit receives the NF permeate from the NF unit 104, concentrate the SWRO brine from the NF permeate, and output the concentrated SWRO brine to the post treatment process 112. Moreover, purified water can be produced as by-product (e.g., portion of water 118). In the regeneration step of the draw solution 110, the purified water (e.g., portion of water 118) can be produced while the draw solution is being concentrated and recirculated for continuous FO operation. For example, the regeneration method can be a thermal method in which the water is vaporized from the draw solution, and then the water vapor is condensed to produce purified water. Additionally, for example, the draw solution can be regenerated by a membrane process to selectively separate or filter the water from the diluted draw solution.

As such, the concentrated SWRO brine (from the FO unit 108 or the first MD unit 106) is directed to the post-treatment process 112 before injection into reservoir. In some implementations, the concentrated SWRO brine is used as the injection water 114 without the post-treatment process 112. Moreover, produced purified water (e.g., portion of water 118) from the FO unit 108 or the first MD unit 106 can be used within the plant for various applications or stored in the storage.

The post-treatment process 112 can include degassing (e.g., removal of dissolved gases), iron removal, filtering of impurities or particles, or removal of dissolved oxygen (DO). For example, the concentrated brine can be treated to meet injection requirements (dissolved 02, dissolved CO2/gas, iron, suspended solids, and the like). Moreover, the post-treatment process 112 may also include injection of corrosion inhibitor, scale inhibitor, biocide and pH adjustment. As such, bbased on the post-treatment process 112, the injection water 114 is produced. Such injection water 114 is used to maintain or increase the pressure in the reservoir. In some implementations, such injection water 114 is stored in a separate storage.

In some implementations, the FO process from the FO unit 108 is performed after the MD process from the first MD unit 106. For example, the FO unit 108 can receive the concentrated SWRO brine feed from the MD unit 106, and further concentrate the SWRO brine.

In some implementations, the MD process from the first MD unit 106 is performed after the FO process from the FO unit 108. For example, the first MD unit 106 can receive the concentrated SWRO brine feed from the FO unit 108, and further concentrate the SWRO brine.

Further, as described above, the retentate stream from the NF unit 104 is directed to the second membrane distillation (MD) unit 116. For example, the retentate stream can include multivalent ions (e.g., calcium (Ca), magnesium (Mg), sulfate, a portion of NaCl, etc.), NaCl, other particles, or other substances.

The second MD unit 116 receives the retentate stream from the NF unit 104 and performs membrane distillation (MD) for brine mining 120 and production of the water 118. For example, the retentate stream from the NF 104 can include minerals that were rejected by the NF membrane of the NF unit 104. Regarding the brine mining 120, for example, magnesium in form of magnesium hydroxide presents an opportunity to turn the brine waste into a valuable resource by minimizing the cost of the overall desalination process.

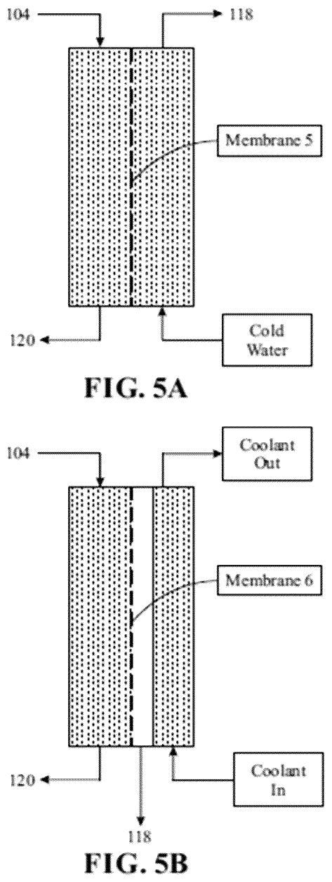

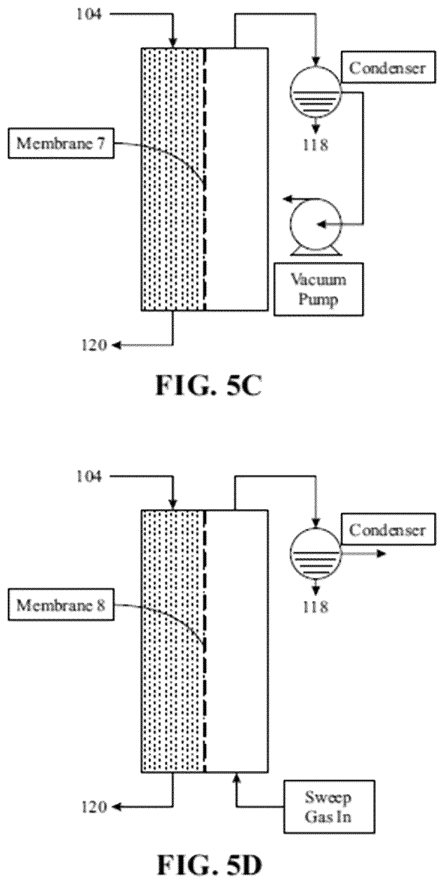

The second MD unit 116 can include or correspond to at least one of a DCMD unit depicted in FIG. 5A, an AGMD unit depicted in FIG. 5B, an VMD unit depicted in FIG. 5C, or a SGMD unit depicted in FIG. 5D.

Regarding the DCMD unit of FIG. 5A, the AGMD unit of FIG. 5B, the VMD unit of FIG. 5C, and the SGMD unit of FIG. 5D, each of these four units can receive the NF retentate from the NF unit 104 and perform membrane distillation for brine mining 120 and production of purified water (e.g., portion of water 118).

Moreover, for example, as depicted in FIGS. 5A-5D, the DCMD unit, the AGMD unit, the VMD unit, and the SGMD unit can be similar to those depicted in FIGS. 3A-3D. For example, the feed (NF retentate of the NF unit 104) can directly contact one side of membrane of the second MD unit 116. The MD driving force may be maintained with at least one of the four mentioned MD options applied on the permeate side.

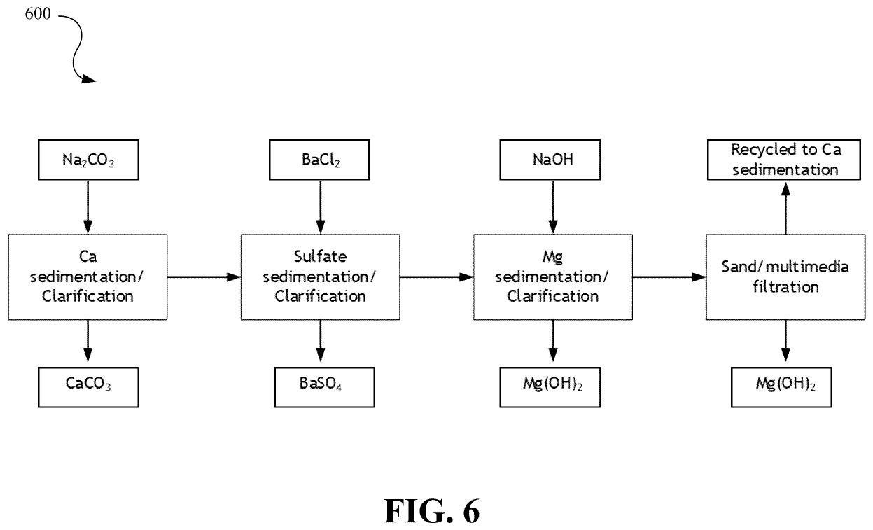

Regarding the brine mining 120, the second MD unit 116 further incorporates, or the system further incorporates after the second MD unit 116, a brine mining process or a brine mining unit that incorporates a valuable mineral production operation. As one example of this valuable mineral production, magnesium production operation is shown in FIG. 6.

FIG. 6 illustrates a schematic diagram 600 of an example of magnesium production based on the NF retentate. For example, retentate stream of the NF unit 104 (NF retentate) goes through calcium (Ca) sedimentation process, sulfate sedimentation process, Mg sedimentation process, and sand/multimedia filtration process in an order, as shown in FIG. 6. For example, a source of carbonate is added (e.g. NaHCO3, Na₂CO₃) to the NF retentate to precipitate calcium as calcium carbonate (CaCO₃), and the pH and operation conditions can be optimized (or modulated) to maximize the Ca²⁺ precipitation and minimize the Mg²⁺ loss. The participated CaCO₃ is removed by filtration after settling. Thereafter, barium chloride (BaCl₂) is added to remove sulfate in the form of barium sulfate (BaSO₄). The formed BaSO₄ is removed by settling or filtration.

Once the calcium and the sulfate have been largely removed, magnesium (Mg) is precipitated as magnesium hydroxide (Mg(OH)₂) by adjusting the pH using a base such as sodium hydroxide (NaOH). As the pH reaches the desired level, magnesium in the stream starts to precipitate as Mg(OH)₂. Further, the stream can be allowed to settle in a sedimentation tank or a clarifier. The magnesium hydroxide precipitates can settle at the bottom while the decant is being passed through a filtration system, such as sand or multimedia filters. Finally, the filtered stream can be recycled back to maximize recovery. As such, the magnesium in the form of magnesium hydroxide is produced and stored.

Moreover, the purified water (e.g., portion of water 118) produced from the second MD unit 116 can be used within the plant for various applications or stored in the storage.

In some implementations, the SWRO brine feed 102 of the schematic diagram 100 is supplanted with the brine that is produced from the reverse osmosis (RO).

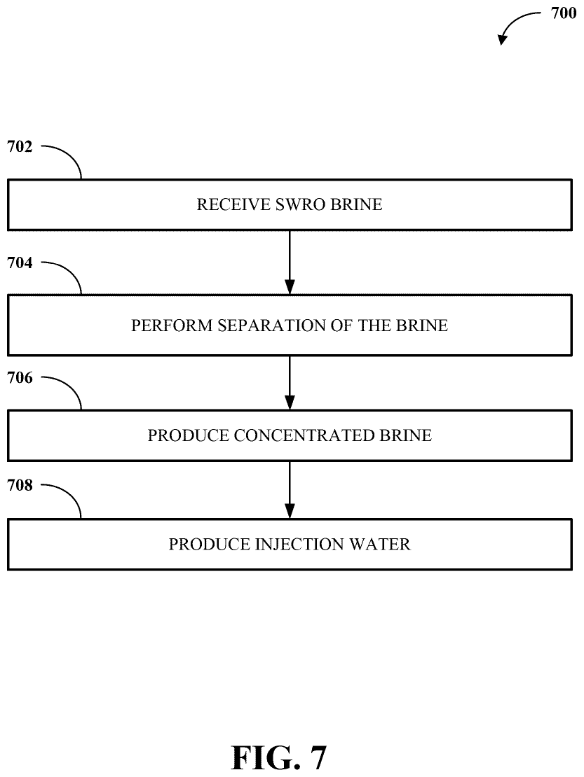

FIG. 7 is a block diagram 700 of an example of production of injection water based on SWRO brine. For example, the block diagram 700 can implement, be implemented by, or implemented in conjunction with, the system and implementations of FIG. 1.

At 702, brine that is produced based on a reverse osmosis of water is received (e.g., SWRO brine, Brackish water (BW), RO brine) is received. For example, NF unit (e.g., the NF unit 104) can receive the SWRO brine or the BWRO brine.

At 704, separation of the brine is performed. Performing the separation of the brine includes performing a rejection of sulfate of the brine at a rate greater than or equal to a certain rejection rate (e.g., rejection threshold rate for sulfate). Moreover, performing the separation of the brine can further include performing a rejection of NaCl at a rate less than or equal to a certain rejection rate (e.g., rejection threshold rate for NaCl). For example, the rejection rate of the NaCl can be less than 60% and the rejection rate of the sulfate can be greater than 90%.

Moreover, when the NF unit performs nanofiltration to thereby separate or reject the NaCl and the sulfate as described above, the NF unit can generate (i) a permeate stream that includes reduced NaCl and sulfate concentration and (ii) retentate stream that includes rejected part of NaCl and majority of sulfate along with other rejected particles or substances.

In some implementations, the rejection threshold rate for the NaCl is 60% and the rejection threshold rate for the sulfate is 90%. For example, the rejection rate of the NaCl can be less than 60% and the rejection rate of the sulfate can be higher than 90%.

In some implementations, based on the separation or rejection, the sulfate concentration in the permeate stream is reduced to less than or equal to 500 ppm.

In some implementations, the NF unit corresponds to a multi-NF unit. For example, to meet the specific requirements of the injection water, the sulfate concentration can be closely monitored, and if necessary, the permeate stream can be fed to another NF unit. For example, in such case (e.g., permeate stream being fed to another NF unit), the permeate can pass through an energy recovery device (as shown in FIG. 2) to recover energy and pressurize the permeate stream from a first NF unit (e.g., the first NF unit 202), which then passes through a booster pump before being fed to a second NF unit (e.g., the second NF unit 204). The multi-NF unit can lower the sulfate concentration to less than or equal to 500 ppm.

For example, regarding the multi-NF unit, a first nanofiltration is performed to generate a first permeate stream, and when the first permeate stream is higher than the threshold value of sulfate concentration (e.g., 500 ppm), a second nanofiltration of the first permeate stream is performed to generate a second permeate stream. As such, multistage nanofiltration is performed until the sulfate concentration in the permeate stream is reduced to less than or equal to threshold value (e.g., 500 ppm). Moreover, ERD can be used to recover retentate stream pressure and pre-compress the feed stream, as described above with respect to the discussion of the NF unit 104. In some implementations, (i) when the first permeate stream does not satisfy or is higher than the threshold value of sulfate concentration (e.g., 500 ppm) and (ii) prior to performing a second nanofiltration at the second NF unit, the permeate stream passes through the ERD.

Moreover, performing the separation of the brine includes feeding the permeate stream from the NF unit to a first MD unit (e.g., the first MD unit 106) or a FO unit (e.g., the FO unit 108) to produce concentrated brine.

In some implementations, the retentate stream from the NF unit is directed to a second MD unit (e.g., the second MD unit 116). As described above with respect to the discussion of the second MD unit 116, the second MD unit performs membrane distillation (MD) for brine mining and production of the water. For example, the retentate stream from the NF can include minerals that were rejected by the NF membrane of the NF unit. For example, regarding the brine mining, magnesium (Mg) in form of magnesium hydroxide is formed and stored, as described above. For example, producing the magnesium hydroxide includes separating calcium from the retentate based on adding NaHCO₃ or Na₂CO₃ to the retentate, separating sulfate from the retentate by adding BaCl₂ to the retentate, and precipitating magnesium hydroxide from the retentate by adding NaOH. Moreover, after precipitating magnesium hydroxide from the retentate, the retentate is recycled back to further perform calcium sedimentation where the calcium is separated from the retentate based on adding the NaHCO₃ or the Na₂CO₃ to the retentate.

At 706, concentrated brine is produced. For example, based on the separation of the brine through the first MD unit or the FO unit, the concentrated brine is produced. For example, the first MD unit receives the permeate stream from the NF unit and performs a membrane distillation to concentrate the brine of the permeate stream. For example, the FO unit receives the permeate stream from the NF unit and perform the forward osmosis to concentrate the brine of the permeate stream. As such, TDS level of the brine can be increased. Moreover, regarding the FO unit, as described above with respect to the discussion of FIG. 1, draw solution can be utilized, regenerated, and circulated at the FO unit. Moreover, as described above with respect to the discussion of FIG. 1, a purified water is produced from the first MD unit or the FO unit, in which the purified water can be used within a plant for various applications or stored in a storage.

In particular, performing the nanofiltration by the NF unit before any other process (e.g., MD, FO) to remove sulfate or partial monovalent ions would lead to production of relatively lower TDS than feed (SWRO brine) prior to the subsequent process (e.g., MD, FO), which in turn, would enhance the efficiency of the MD or the FO process and lead to relatively easier selection of material and configuration of the process, as described above.

In some implementations, the first MD unit or the second MD unit corresponds to or includes at least one of a direct contact membrane distillation unit, a vacuum membrane distillation unit, an air-gap membrane distillation unit, or a sweep gas membrane distillation unit.

In some implementations, the forward osmosis from the FO unit is performed after the membrane distillation process from the first MD unit. For example, the FO unit can receive the concentrated brine feed from the first MD unit, and further concentrate the concentrated brine feed.

In some implementations, the membrane distillation from the first MD unit is performed after the forward osmosis from the FO unit. For example, the first MD unit can receive the concentrated brine feed from the FO unit, and further concentrate the concentrated brine feed.

At 708, injection water is produced. For example, produced concentrated brine is directed to a post-treatment process to produce the injection water, before injection to reservoir.

The post-treatment process can include degassing (e.g., removal of dissolved gases), iron removal, further filtering of impurities or particles, or removal of dissolved oxygen (DO). For example, the produced concentrated brine can be treated to meet injection requirements (dissolved O2, dissolved CO2, iron, suspended solids, and the like). Moreover, the post-treatment process may also include remineralization to add essential minerals and pH adjustment. As such, based on the post-treatment process, the injection water is produced. Such injection water is used to maintain or increase the pressure in the reservoir. Moreover, such injection water can be stored in a separate storage. In some implementations, the concentrated brine is used as the injection water without the post-treatment process.

### Examples

Rejection rates of NaCl and sulfate based on various operating conditions.

An NF test for the NF unit 104 has been conducted to confirm the technical feasibility of using the commercial NF membrane. For example, membranes from Sepro membranes, Inc. (e.g., membrane model NF4) were used. Based on the data obtained from Tanajib RO plant in Saudi Arabia, synthetic RO brine water was prepared and used as the feed of the NF test. Experimental conditions for the NF test are summarized in Table 1 below.

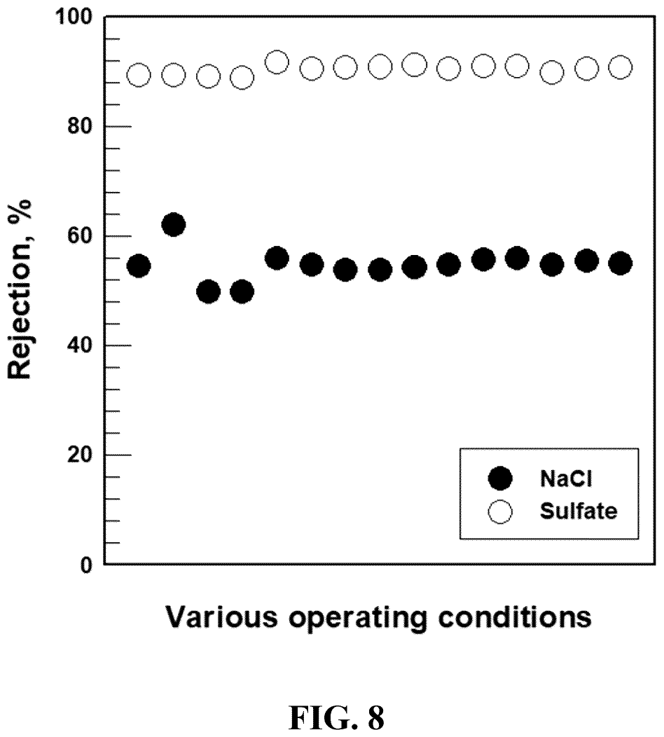

In this experiment, various operating conditions have been examined and the effect of flow rate, feed temperature and feed composition on NaCl and sulfate rejection have been analyzed. In this experiment, the rejection rate of NaCl and sulfate were monitored, and it was determined that the NaCl rejection varies between 49-62% while sulfate rejection is in the range of 90-92%. As shown in graph in FIG. 8, compared to sulfate removal, NaCl rejection was influenced more strongly by the operating conditions. By adjusting and optimizing the operating conditions (e.g., recovery rate of water, feed pressure, flow rate, membrane area), the sulfate removal efficiency can be enhanced while the NaCl rejection can be reduced. For example, the operating conditions include adjustment of transmembrane pressure (TMP), feed water temperature, flow rate across the membrane surface, and ratio of permeate to feed flow. For example, adjusting the TMP can influence the flux (flow rate per unit area of membrane) and separation efficiency, while excessively high pressures can increase fouling and scaling, reducing membrane lifespan. For example, higher feed temperature generally increase the permeate flux due to reduced water viscosity and increased diffusion rates. However, temperature extremes can damage the membrane or alter its selectivity. Moreover, for example, increasing the cross-flow velocity can help minimize the buildup of a concentration polarization layer and reduce membrane fouling. This must be balanced with energy costs associated with higher pumping rates. Moreover, for example, higher recovery rates indicate that more product water is obtained from the feed, but this can also lead to increased concentration of solutes near the membrane surface, potentially leading to fouling and decreased performance. Accordingly, by adjusting and optimizing the operating conditions, the sulfate removal efficiency can be enhanced while the NaCl rejection can be reduced.

TABLE 1
Sulfate removal using commercial NF membrane.

| | |
|---|---|
| Membrane | Sepro membranes / NF4 |
| manufacturer / model | |
| Feed water | Synthetic RO brine water |
| | (Aramco operating SWRO) |
| Operating pressure, psi | 225 |
| Operating | 25 / 35 / 45 |
| temperature, ° C. | |
| Feed compositions | Feed 1: 60,000 ppm NaCl + 2,000 ppm MgSO₄ |
| | Feed 2: 80,000 ppm NaCl + 2,000 ppm MgSO₄ |
| TDS range in | 36,500~71,800 ppm |
| NF permeate | |

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method for producing an injection water for a reservoir, the method comprising:
receiving a brine that is produced based on a reverse osmosis of water;
performing a separation of the brine, wherein the separation comprises at least one of a filtration, a membrane distillation, or a forward osmosis;
producing, based on the separation of the brine, a concentrated brine, wherein the concentrated brine has a lower sulfate level and NaCl level and a higher total dissolved solids (TDS) level than the brine; and
producing, based on the concentrated brine, the injection water suitable for use in maintaining a reservoir pressure.

2. The method of claim 1, wherein performing the separation of the brine includes performing a rejection of NaCl of the brine at a rejection rate less than or equal to 60% and a rejection of sulfate of the brine at a rejection rate equal to or greater than 90%.

3. The method of claim 1, wherein performing the separation of the brine includes:
performing a nanofiltration to generate a permeate stream; and
feeding the permeate stream to at least one of a membrane distillation unit or a forward osmosis unit to produce the concentrated brine.

4. The method of claim 1, wherein performing the separation of the brine includes:
performing a first nanofiltration to generate a first permeate stream;
based on the first permeate stream not satisfying lower than a threshold value of sulfate concentration, performing a second nanofiltration of the first permeate stream to generate a second permeate stream; and
based on the second permeate stream satisfying lower than the threshold value of the sulfate concentration, feeding the second permeate stream to at least one of a membrane distillation unit or a forward osmosis unit to produce the concentrated brine.

5. The method of claim 4, wherein performing the separation of the brine includes:
based on the first permeate stream not satisfying lower than the threshold value of sulfate concentration and prior to performing the second nanofiltration, directing the first permeate stream to an energy recovery device.

6. The method of claim 4, wherein the threshold value is 500 ppm.

7. The method of claim 1, wherein performing the separation of the brine includes:
performing a nanofiltration to generate a permeate stream; and
feeding the permeate stream to both a membrane distillation unit and a forward osmosis unit to produce the concentrated brine.

8. The method of claim 7, wherein producing the concentrated brine includes:
based on the forward osmosis unit utilizing a draw solution, producing at least a portion of the concentrated brine;
regenerating the draw solution; and
circulating the regenerated draw solution to the forward osmosis unit.

9. The method of claim 7, comprising:
based on feeding the permeate stream to both a membrane distillation unit and a forward osmosis unit, producing water; and
storing the water.

10. The method of claim 1, wherein:
performing the separation of the brine includes:
performing a nanofiltration to generate a permeate stream and a retentate stream, and
feeding the permeate stream to at least one of a membrane distillation unit or a forward osmosis unit to produce the concentrated brine; and
the method comprises:
producing magnesium hydroxide based on feeding the retentate stream to a second membrane distillation unit.

11. The method of claim 10, wherein producing the magnesium hydroxide includes:
separating calcium from retentate of the retentate stream based on adding NaHCO₃ or Na₂CO₃ to the retentate;
separating sulfate from the retentate by adding BaCl₂ to the retentate; and
precipitating magnesium hydroxide from the retentate by adding NaOH.

12. The method of claim 11, wherein the second membrane distillation unit corresponds to at least one of a direct contact membrane distillation unit, a vacuum membrane distillation unit, an air-gap membrane distillation unit, or a sweep gas membrane distillation unit.

13. The method of claim 11, comprising:
storing the magnesium hydroxide.

14. The method of claim 11, comprising:
after precipitating magnesium hydroxide from the retentate, recycling the retentate back to further perform calcium sedimentation where the calcium is separated from the retentate based on adding the NaHCO₃ or the Na₂CO₃ to the retentate.

15. A system comprising:
a nanofiltration unit configured to:
receive a brine that is produced based on a reverse osmosis of water,
perform a rejection of NaCl and sulfate of the brine, and
generate, based on the brine, a permeate and a retentate; and
a membrane distillation unit configured to:
receive the permeate from the nanofiltration unit; and
generate, based on the permeate, a concentrated brine for use in producing injection water for a reservoir, wherein the concentrated brine has a lower sulfate level and NaCl level and a higher total dissolved solids (TDS) level than the brine.

16. The system of claim 15, comprising:
a forward osmosis unit configured to:
receive the permeate from the nanofiltration unit; and
generate, based on the permeate, at least a portion of the concentrated brine.

17. The system of claim 16, wherein the nanofiltration unit is configured to:
perform a first nanofiltration of the brine to generate a first permeate; and
based on the first permeate not satisfying lower than a threshold value of sulfate concentration, performing a second nanofiltration of the first permeate to generate a second permeate; and
based on the second permeate satisfying lower than the threshold value of the sulfate concentration, feeding the second permeate to the membrane distillation unit and the forward osmosis unit to produce the concentrated brine,
wherein the second permeate corresponds to the permeate.

18. The system of claim 17, wherein the threshold value is 500 ppm.

19. The system of claim 17, comprising:
a second membrane distillation unit configured to:
receive the retentate from the nanofiltration unit; and
produce magnesium hydroxide based on the retentate.

20. The system of claim 19, wherein producing the magnesium hydroxide comprises:
separating calcium from the retentate based on adding NaHCO₃ or Na₂CO₃ to the retentate;
separating sulfate from the retentate by adding BaCl₂ to the retentate; and
precipitating magnesium hydroxide from the retentate by adding NaOH.
